(19) United States
(12) Patent Application Publication
(10) Pub. No.: US 2007/0276568 A1
(43) Pub. Date: Nov. 29, 2007

(54) SEAT POSITION CONTROL DEVICE FOR VEHICLE

(75) Inventor: Kenji TOZU, Yokkaichi-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: AISIN SEIKI KABUSHIKI KAISHA, Kariya-shi (JP)

(21) Appl. No.: 11/683,723

(22) Filed: Mar. 8, 2007

(30) Foreign Application Priority Data
Mar. 29, 2006 (JP) 2006-092143

(51) Int. Cl. G06F 17/00; B60N 2/02

(52) U.S. Cl. 701/49; 297/217.3

(57) ABSTRACT

A seat position control device for a vehicle includes a lateral direction actuator for moving a position of a seat of the vehicle in a lateral direction of the vehicle, a turning direction actuator for moving the position of the seat of the vehicle in a turning direction of the vehicle a motion condition identification device for identifying a motion condition of the vehicle, a lateral direction drive control device for moving the position of the seat in the lateral direction of the vehicle by driving the lateral direction actuator based on the motion condition of the vehicle identified by the motion condition identification device and a turning direction drive control device for moving the position of the seat in the turning direction of the vehicle by driving the turning direction actuator based on the motion condition of the vehicle identified by the motion condition identification device.

This application is based on and claims priority under 35 U.S.C. § 119 to Japanese Patent Application 2006-092143, filed on Mar. 29, 2006, the entire content of which is incorporated herein by reference.

### FIELD OF THE INVENTION

The present invention relates to a seat position control device for a vehicle ensuring an optimal posture of a driver seated in a vehicle seat during driving.

### BACKGROUND

Conventionally, various seat control devices have been devised for controlling an occupant in a vehicle seat. One of such devices is disclosed in JP 2005-119559A. The disclosed seat position control device adjusts the vehicle seat position based on road information acquired from the terminal device of a car navigation system and a vehicle running condition detected by various sensors. Another known device discloses a seat position adjustment device for tilting the seat back in response to the signal conditions of various switches, such as, seatbelt switch, door switch or ignition switch and further in response to lateral acceleration specified by the detecting results from the vehicle speed sensor and a steering sensor (JP8-216747A). Further, another known device disclosed in JP7-096784A includes an occupant posture adjustment device for easily adjusting the seat position to have the driver to be positioned with a proper view and a proper posture position for driving by adjusting the vehicle seat in front/backward or up/downward directions as well as by adjusting the positions of the acceleration and/or the brake pedals in front/backward directions. (JP7-96784A).

According to the seat position control device disclosed in the JP 2005-119559A, inclination angle of the seat back, front/backward position of the seat cushion, inclination angle of the seat assembly, seat profile, seat hardness and the position of the armrest are controlled. According to the position adjustment device disclosed in the JP8-216747A, inclination movement of the seat, the front/backward movements and up/downward movements of the seat are controlled. According to the position adjustment device disclosed in the JP8-216747A, the positions of the seat in front/backward directions and the up/downward directions and the positions of the acceleration pedal and the brake pedal in front/backward direction are controlled. In these known arts, no disclosure regarding the positions of the vehicle seat in width direction (lateral direction) and turning direction of the vehicle are made. Accordingly, it would be difficult for these known arts to control properly the posture of the occupant seated in the seat when acceleration in lateral direction is generated upon turning of the vehicle. Further, when the slipding (sideward slipping) occurs at the center of gravity of the vehicle, the driver cannot adjust the difference between the driver's view direction and the vehicle advancing direction.

The present invention is made in view of the above conventional problems and provides a seat position control device for a vehicle to properly adjust the posture of the driver of the vehicle depending on the situations.

### SUMMARY OF THE INVENTION

According to an aspect of the present invention, a seat position control device for a vehicle includes a lateral direction actuator for moving the position of the seat in a lateral direction of the vehicle, a turning direction actuator for moving the position of the seat in a turning direction of the vehicle, a vehicle condition identifying device for identifying a vehicle condition, a lateral direction drive control device for moving the position of the seat in the lateral direction by driving the lateral direction actuator based on the vehicle condition identified by the vehicle condition identifying device and a turning direction drive control device for moving the position of the seat in the turning direction by driving the turning direction actuator based on the vehicle condition identified by the vehicle condition identifying device.

The vehicle condition identified by the vehicle condition identifying device includes a yaw rate generated in the vehicle and the lateral direction drive control device drives the lateral direction actuator to move the position of the seat in a lateral direction of the vehicle with a target value of a lateral acceleration which is identified based on a distance from the center of gravity to the position of the seat, an angle formed by the line segment connecting the center of gravity of the vehicle and the position of the seat relative to the lateral direction of the vehicle and a yaw rate identified by the vehicle condition identifying device.

The vehicle condition identified by the vehicle condition identifying device includes yaw rate generated at the vehicle and the turning direction drive control device drives the turning direction actuator to move the position of the seat in a turning direction of the vehicle with a target value of rate of change of yaw rate which is identified by the vehicle condition identifying device.

The seat position control device further includes a slip angle-identifying device for identifying a slip angle generated at the center of gravity of the vehicle based on the vehicle condition identified by the vehicle condition-identifying device. The turning direction drive control device drives the turning direction actuator to move the position of the seat in a turning direction of the vehicle with a target value of a rate of change of slip angle which is identified based on the vehicle condition identifying device.

### BRIEF DESCRIPTION OF THE DRAWINGS

The foregoing and additional features and characteristics of the present invention will become more apparent from the following detailed description considered with reference to the accompanying drawings, wherein:

FIG. 1 is a schematic view of a seat position control device for a vehicle according to an embodiment of the present invention;

FIG. 2 is a logic illustration of a control information processing portion 24 of the seat position control device according to the embodiment of the present invention;

FIG. 3 is a view schematically illustrating a position of a seat relative to the center of gravity of the vehicle;

FIG. 4 is a flowchart showing an example of execution of the control information processing portion according to the embodiment of the present invention;

FIG. 5 is an example of setting coefficient M_{dγ};

FIG. 6 is a flowchart showing an example of automatic position control judgment processing;

FIG. 7 is an example of setting coefficients K_{g0}, Kᵣ₀, K_{dγ0} and K_{b0};

FIG. 8 is a flowchart showing an example of the first active control processing;

FIG. 9 is an example of setting coefficients K_{g1};

FIG. 10 is a schematic view illustrating a performance characteristics of operation amount U_{Gy};

FIG. 11 is a schematic view illustrating a performance characteristics of operation amount U_{γ};

FIG. 12 is a schematic view illustrating a performance characteristics of operation amount U_{dγ};

FIG. 13 is a flowchart showing an example of the second active control processing; and

FIG. 14 is a schematic view illustrating a performance characteristics of operation amount U_{b};

### DETAILED DESCRIPTION

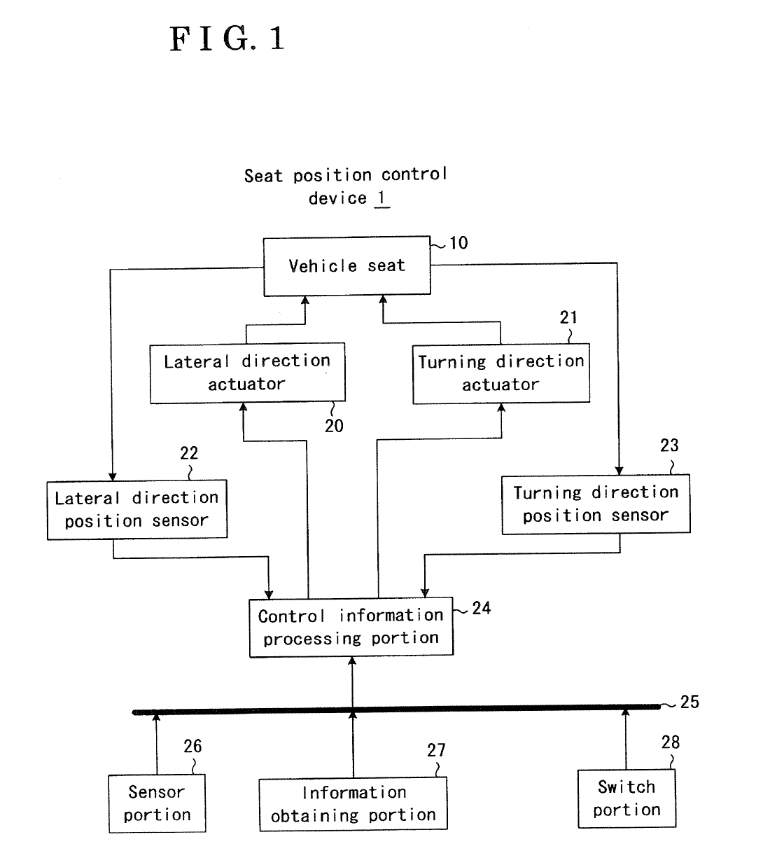

Embodiments of the present invention will be explained with reference to the attached drawings. According to a first embodiment of the present invention, as illustrated in FIG. 1, a seat position control device 1 for a vehicle is a device for controlling a position of the vehicle seat in a lateral direction of the vehicle (right and left direction of the vehicle) and in a turning direction (rotating direction). As shown in FIG. 1, the seat position control device 1 includes a lateral direction actuator 20, a turning direction actuator 21, a lateral direction position sensor 22, a turning direction position sensor 23 and a control information-processing portion 24. The control information-processing portion 24 is connected to a sensor portion 26, an information obtaining portion 27 and a switch portion 28 via a network path 25 forming an in-vehicle network such as LAN (Local Area Network) formed by, for example, CAN (Controller Area Network).

The lateral direction actuator 20 is formed by an electric motor such as a stepping motor or a DC motor. The actuator 20 actuates the vehicle seat 10 to move in a lateral direction with respect to the vehicle. The turning direction actuator 21 is formed by an electric motor as well. The actuator 21 actuates the vehicle seat 10 to move in a turning direction with respect to the vehicle. These actuators 20 and 21 are connected to the vehicle seat 10 via a link mechanism such as gears or sliders. The connection can be of any type as long as the actuators can move the position of the seat 10.

The lateral direction position sensor 22 is a sensor for detecting position ys of the vehicle seat 10 in lateral direction of the vehicle. The turning direction position sensor 23 is a sensor for detecting a displacement amount (rotation amount) rs from a neutral position of the seat 10. These sensors 22 and 23 may be included in the sensor portion 26 via the network pass 25 instead of separately being provided.

The control information-processing portion 24 is formed by an in-vehicle microprocessor such as ECU (Electronic Control Unit) for driving the lateral direction actuator 20 and the turning direction actuator 21 for moving the position of the seat according to the vehicle condition. The information-processing portion 24 includes a CPU (Central Processing Unit), RAM (Random Access Memory), ROM (Read Only Memory) and an auxiliary memory device (such as magnetic disc drive, optical disc drive or flush memory). The CPU executes processing based on the computer readable programs memorized in the memory media such as ROM, RAM or the auxiliary memory device.

The sensor portion 26 detects various conditions of the vehicle during running and the operation conditions of the operation mechanisms of the vehicle such as steering wheel operation. For an example, the sensor portion 26 includes a vehicle speed sensor, yaw rate sensor and lateral acceleration sensor (lateral G-sensor) for detecting the vehicle condition. The sensor portion 26 further includes a steering angle sensor for detecting the operation condition of the steering wheel. The sensor portion 26 may be provided with a seat position sensor for detecting position of the seat in front/backward direction.

The vehicle speed sensor is a sensor for detecting the vehicle running speed. The yaw rate sensor is a sensor for detecting yaw rate generated in the vehicle. The lateral acceleration sensor is a sensor for detecting the acceleration in lateral direction of the vehicle generated at a particular portion such as the center of gravity of the vehicle. The steering angle sensor is a sensor for detecting a steering operation angle from the neutral position of the steering wheel to a certain rotational angle. The seat front/backward position sensor is a sensor for detecting the position of the seat in front/backward direction (vehicle longitudinal direction).

For example, the sensor portion inputs information to the control information-processing portion 24. Such information includes a vehicle speed detection information indicating the detected results of the vehicle running speed by the vehicle speed sensor, yaw rate detection information indicating the detected results of the yaw rate sensor, lateral acceleration detection information indicating the detected results of the lateral acceleration sensor, steering angle detection information indicating the detected results of the steering angle detected by the steering angle sensor and a seat position detection information of the seat 10 in front/backward direction detected by the seat front/backward position sensor.

The information-obtaining portion 27 obtains information about the vehicle running conditions from, such as for example, car navigation system or road surface conditions. The control information-processing portion 24 partially or fully receives information from the information-obtaining portion 27 about the road surface conditions of the road on which the vehicle is running. A portion of the road surface information may be sent from the sensor portion 26 to the control information-processing portion 24. The road surface information includes whether the road is a paved road or a gravel road, whether the asphalt road or the concrete road, or the highway or not, whether the road surface is wet and slippery or dry, or the road is frozen or not, or the road is inclined upward or downward or flat. The road surface information includes at least one of them.

The information-obtaining portion 27 obtains information by which the turning radius of the running road can be estimated from the map information of the car navigation system. The information obtained here is sent to the control information-processing portion 24 as the information of turning radius.

The switch portion 28 switches over various mechanisms equipped in the vehicle or detects conditions thereof. The switch portion 28 includes a change over switch, a door switch, a seatbelt switch and an ignition switch.

The change over switch of the switch portion 28 is a switch for selectively changing over the position control operation of the seat 10. The door switch detects opening or closing condition of the vehicle door. The seatbelt switch detects whether the occupant fastens seatbelt or not. The ignition switch is a switch for detecting ON/OFF condition of the engine (ignition key operation). The switch portion 28 sends switch signals indicating ON/OFF or Open/Close conditions of each switch to the control information-processing portion 24.

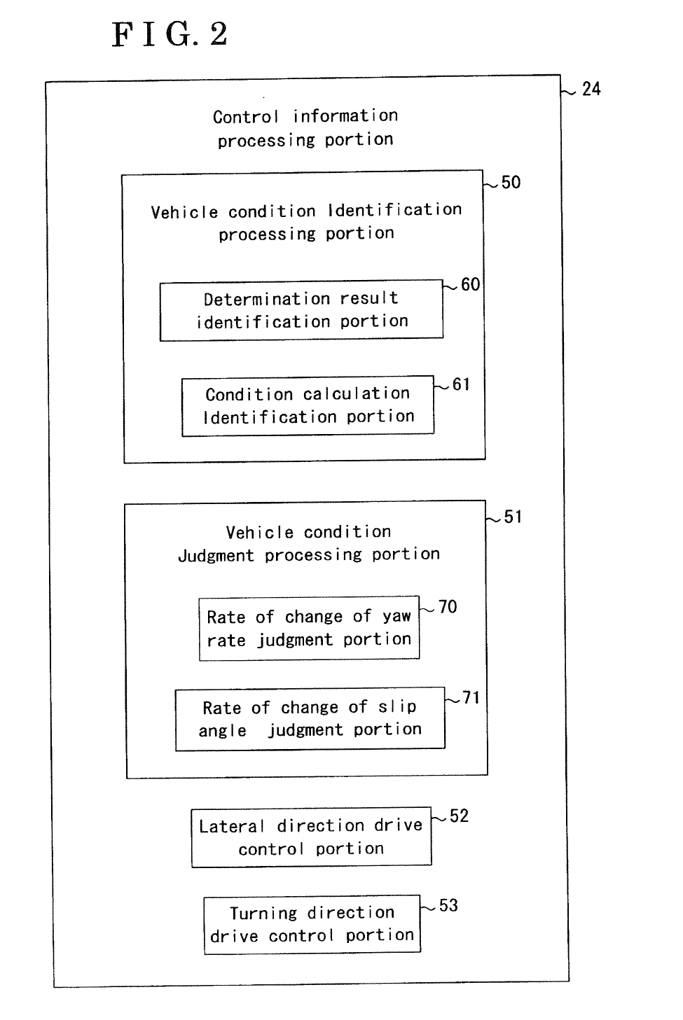

FIG. 2 shows a logic diagram of the control information-processing portion 24. Processing is executed by the CPU in the control information-processing portion 24 by reading out predetermined programs and set data from the memory media such as ROM, RAM or the auxiliary memory device. The control information-processing portion 24 includes a vehicle condition identification processing portion 50, a vehicle condition judgment processing portion 51, a lateral direction drive control portion 52 and a turning direction drive control portion 53. The vehicle condition identification processing portion 50 functions as identification of a vehicle condition including a motion condition of the vehicle such as yaw rate generated in the vehicle and steering wheel angle when the vehicle is turning.

The vehicle condition identification-processing portion 50 executes process for identifying various vehicle conditions including vehicle running conditions and operation conditions. For example, the vehicle condition identification-processing portion 50 includes a detection result identification portion 60 and a condition calculation portion 61.

The detection result identification portion 60 identifies detection results of various conditions regarding the vehicle by the information and signals received from the lateral direction position sensor 22, the turning direction position sensor 23, sensor portion 26, the information-obtaining portion 27 and the switch portion 28. For example, the detection result identification portion 60 identifies the vehicle speed V by the vehicle speed detection information from the sensor portion 26. Also the detection result identification portion 60 identifies the yaw rate γ generated at the center of gravity of the vehicle by the yaw rate detection information from the sensor portion 26. Further the detection result identification portion 60 identifies lateral acceleration G_{y} generated at the center of gravity of the vehicle by the lateral acceleration information from the sensor portion 26.

In addition, the detection result identification portion 60 identifies the vehicle turning radius R based on the steering angle detection information from the sensor portion 26, turning radius estimated information from the information obtaining portion 27 or the lateral acceleration G_{y} identified by the detection result identification portion 60.

Further, the detection result identification portion 60 identifies a position ys of the seat 10 in a lateral direction of the vehicle detected by the lateral direction position sensor 22 and a displacement amount (rotation angle) rs of the seat 10 in rotational direction detected by the turning direction position sensor 23.

The condition calculation identification portion 61 executes a predetermined calculation based on various signals and information received from the sensor portion 26 and the various conditions identified by the detection result identification portion 60. Thus the condition calculation identification portion 61 identifies the vehicle conditions different from the conditions identified by the detection result identification portion 60. The condition calculation identification portion 61 identifies the vehicle conditions by the execution of the operation programs by the CPU in the control information-processing portion 24. Also the condition calculation identification portion 61 identifies the vehicle conditions corresponding to the execution of calculation by referring to the data table prepared and memorized in advance in the ROM by CPU in the control information processing portion 24. The data table prepared and memorized in advance in the ROM may indicate relationship between the signals and information from the sensor portion 26 predetermined by the test or the vehicle conditions identified by the detection result identification portion 60 and the vehicle conditions identified by the condition calculation identification portion 61.

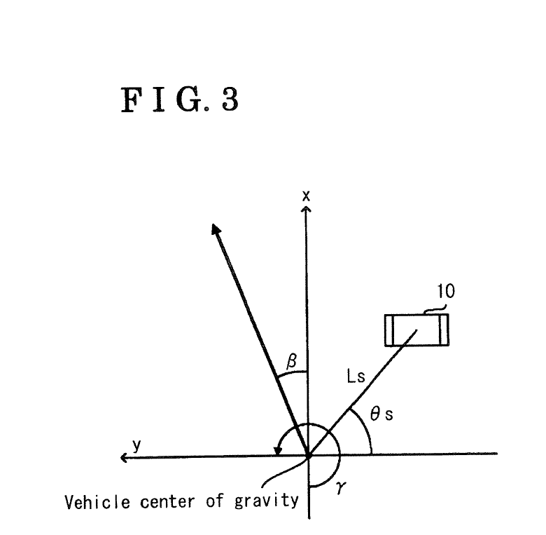

The condition calculation identification portion 61 identifies distance Ls from the center of gravity of the vehicle to the position of the seat 10 and the angle θs formed by the line segment connecting the center of gravity and the position of the seat relative to the lateral direction of the vehicle (y-axis in FIG. 3). The x-axis in this drawing (FIG. 3) indicates the vehicle front/backward direction wherein vehicle frontward is assumed to be the positive area and the vehicle rearward is assumed to be the negative area. The y-axis in FIG. 3 indicates the lateral direction of the vehicle, wherein the left side of the vehicle is assumed to be the positive area whereas the right side is assumed to be the negative area.

The condition calculation identification portion 61 identifies the change of rate of yaw rate dγ/dt at the center of gravity of the vehicle based on the yaw rate γ generated at the center of gravity identified by the detection result identification portion 60. The condition calculation identification portion 61 further identifies slip angle β generated at the center of gravity of the vehicle based on the vehicle speed V, lateral acceleration Gy and the yaw rate γ identified by the detection result identification portion 60. Here, the slip angle β generated at the center of gravity of the vehicle can be identified by the calculation of the formula below (or using the data table corresponding to the calculation).

β=∫(Gy/V−γ)dt Formula:

Further, the calculation identification portion 61 identifies the slip ratio dβ/dt at the center of gravity corresponding to the change of rate of slip angle β.

The vehicle condition judgment processing portion 51 judges whether the vehicle condition identified by the vehicle condition identification-processing portion 50 indicates a predetermined vehicle condition. The vehicle condition judgment-processing portion 51 includes a change of rate of yaw rate judgment portion 70 and a change of rate of slip angle judgment portion 71.

The change of rate of yaw rate judgment portion 70 judges whether the absolute value of change of rate of yaw rate dγ/dt identified by the condition calculation identification portion 61 has reached to a reference value identified as a first change of rate threshold value or not. The reference value as the first change of rate threshold value is an identified set value M_{dγ} (later explained in detail) by referring to the data table prepared in advance at the control information processing portion 24 based on the road surface condition information received from the sensor portion 26 and the information obtaining portion 27 to the control information processing portion 24 and the vehicle speed V identified at the detection result identification portion 60.

Rate of change of slip angle judgment portion 71 judges whether the absolute value of change of rate of slip angle dβ/dt identified by the condition calculation identification portion 61 has reached to a reference value identified as a second change of rate threshold value or not. The reference value as the second change of rate threshold value is a predetermined set value by a test as the threshold value for judging whether the drive control can be performed or not for agreeing the revolution and the rotation movement generated at the seat 10.

The lateral direction drive control portion 52 executes processing for drive controlling of the lateral direction actuator 20. The lateral direction drive control portion 52 moves the position of the seat 10 in a lateral direction of the vehicle by driving the lateral direction actuator 20 based on the conditions of the vehicle identified by the vehicle condition identification processing portion 50. Controlling any of the input pulse frequency of the electric motor forming the actuator 20, motor drive current and motor drive voltage can drive the lateral direction actuator 20.

The turning direction drive control portion 53 executes processing for drive controlling of the turning direction actuator 21. The turning direction drive control portion 53 moves the position of the seat 10 in a turning direction (rotating direction) of the vehicle by driving the turning direction actuator 21 based on the conditions of the vehicle identified by the vehicle condition identification processing portion 50. The turning direction actuator 21 drives in response to any of the input pulse frequency of the electric motor forming the actuator 21, motor drive current and motor drive voltage.

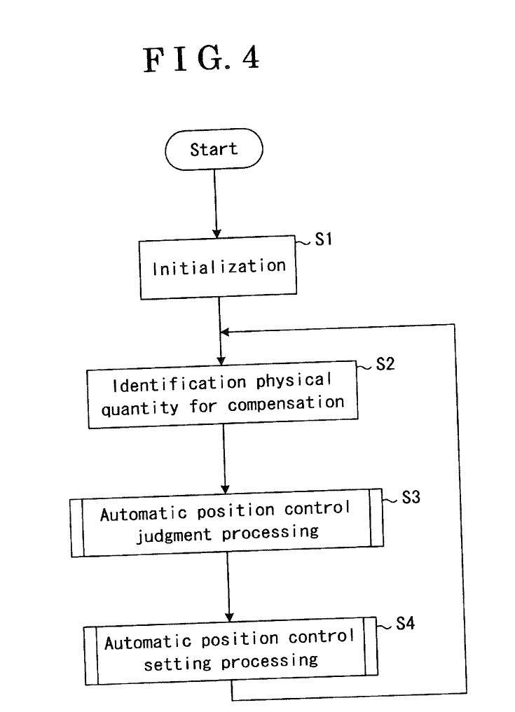

The operation of the seat position control device 1 will be explained hereinafter. FIG. 4 shows the flowchart for executing processes of the control information-processing portion 24. When the execution is started, the initialization is made (step S1). Then a pre-selected physical quantity is identified for compensation by driving the lateral direction actuator 20 and the turning direction actuator 21 (Step S2). The compensation physical quantity by the drive of the lateral direction actuator 20 and the turning direction actuator 21 can be distinguished from the physical quantity identified by actual measurement by putting mark * on the value.

In the step S2, the lateral direction drive control portion 52 identifies the physical quantities for compensation by driving the lateral direction actuator 20 with reference to the data table prepared in advance at the control information processing portion 24 based on the vehicle condition identified at the vehicle condition identification processing portion 50.

In more detail, the lateral direction drive control portion 52 identifies the lateral acceleration G_{ys}* at the vehicle seat 10 as the lateral acceleration to be compensated for as indicated in the following formula (formula 1) based on the distance Ls between the center of gravity of the vehicle identified by the vehicle condition identification processing portion 50 and the position of the seat 10, an angle θs formed by the line segment connecting the position of the seat and the center of gravity with respect to the lateral direction of the vehicle and the yaw rate γ generated at the center of gravity of the vehicle.

G_{ys}*=d/dt(Ls·γ·cosθs) Formula 1:

In step S2, the turning direction drive control portion 53 identifies the physical quantities for compensation by driving the turning direction actuator 21 with reference to the data table prepared in advance at the control information processing portion 24 based on the vehicle condition identified at the vehicle condition identification processing portion 50.

In more detail, the turning direction drive control portion 53 identifies the yaw rate γ* at the vehicle seat 10 as the yaw rate to be compensated for as indicated in the following formula (formula 2) based on the change of rate of the slip angle dβ/dt at the center of gravity of the vehicle identified by the condition calculation identification portion 61 of the vehicle condition identification processing portion 50.

γs*=−dβ/dt Formula 2:

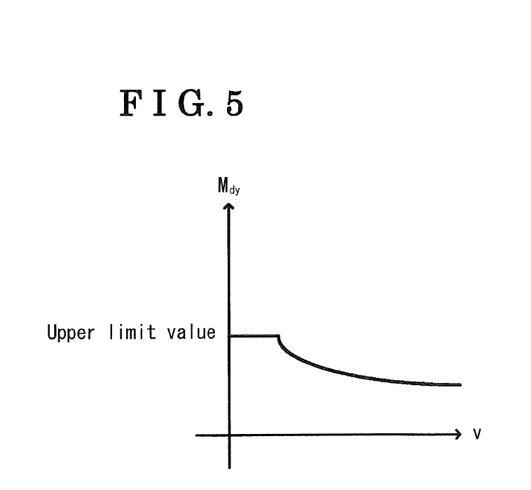

The turning direction drive control portion 53 identifies the change of rate of yaw rate (dγs/dt)* at the center of gravity of the vehicle seat 10 identified by the condition calculation identification portion 61 of the vehicle condition identification processing portion 50 as the yaw rate to be compensated for by the turning direction actuator 21. In the formula 3 bellow, the coefficient M_{dγ} is a set value identified by the data table based on the road surface condition information received from the sensor portion 26 and the information obtaining portion 27 to the control information processing portion 24 and the vehicle speed V identified at the detection result identification portion 60. Such value M_{dγ} can be an upper limit value having an inverse proportion to the vehicle speed V at the area below the predetermined value as is shown in FIG. 5.

(dγs/dt)*=dγ/dt−sin(dγ/dt)M_{dγ} Formula 3:

Further, the turning direction drive control portion 53 identifies the displacement amount (turning angle) of the vehicle seat 10 in turning direction (rotation direction) at the step S2. In more detail, the turning direction drive control portion 53 identifies the turning angle rs* indicated in the following formula 4 based on the turning radius R of the vehicle identified by the detection result identification portion 60 and the slip angle β at the center of gravity of the vehicle identified at the condition calculation identification portion 61 in the vehicle condition identification processing portion 50. The coefficient K_{β} in the formula 4 is a constant (for example, K_{β}=0.6) and the coefficient K_{rad} is a constant (for example, K_{rad}=⅛*π(rad)). The coefficient K_{R} in the formula 4 is a set value defined by the formula, K_{R}=K_{RC}/R−K_{Rb} indicating an inverse proportion to the vehicle turning radius R. In the formula, the K_{RC} and K_{Rb} indicate constant.

rs*=Kβ·β+K_{R}·K_{rad} Formula 4:

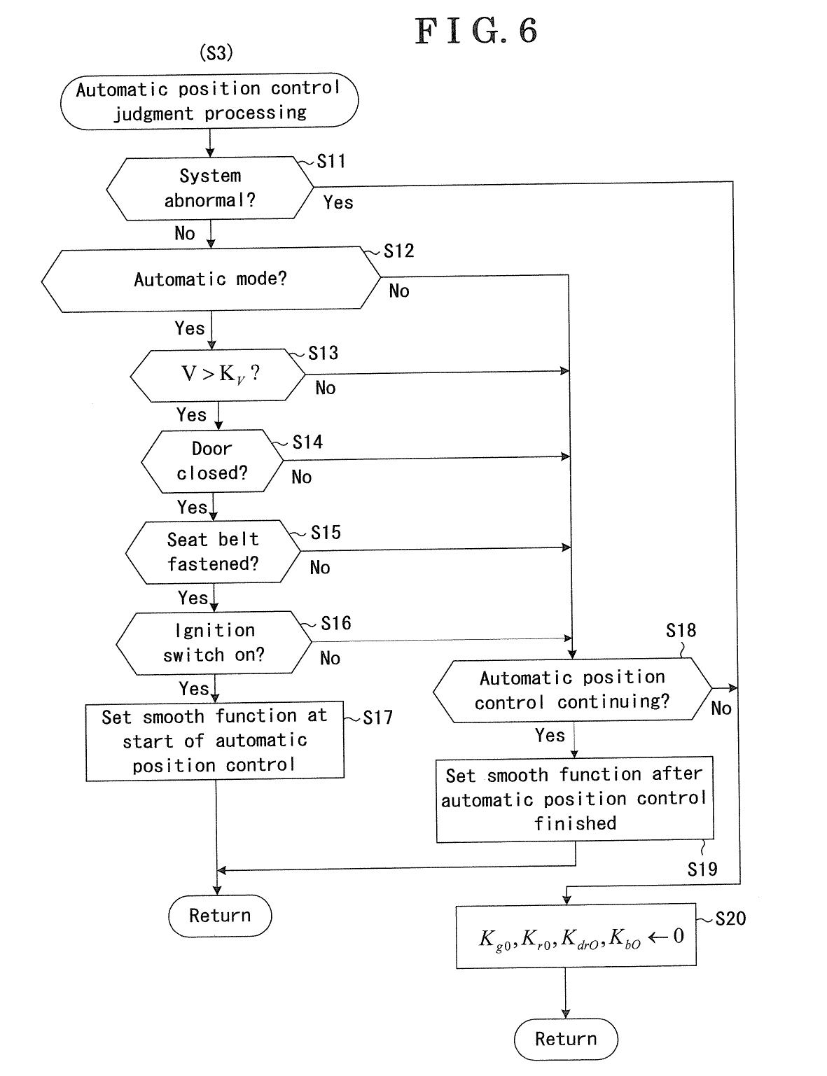

The physical quantities to be compensated for by the lateral direction actuator 20 and the turning direction actuator 21 can be identified by the vehicle condition identification processing portion 50. Following the execution in the step S2, the control information-processing portion 24 executes automatic position control judgment processing in step S3. FIG. 6 shows an example of such automatic position control judgment processing.

In FIG. 6, the step S11 judges whether the system is normally operated or not. If judged to be normal, then the process goes to the step 12 to judge whether the position control device 1 of the vehicle seat 10 is in automatic mode or not, by checking the switch signals from the change over switch in the switch portion 28.

If the mode is judged to be in automatic mode, then the step S13 judges whether the vehicle speed V identified by the detection result identification portion 60 in the vehicle condition identification processing portion 50 exceeds a reference speed Kv or not. In this example, the reference speed Kv is identified to be a threshold speed for executing the automatic position control for the vehicle seat 10 (for example, predetermined to be 10 km/h in this embodiment).

In step S13, if the vehicle speed V exceeds the reference speed Kv, the vehicle door condition is judged at the step S14 whether the vehicle door is closed or not by checking the door switch signal from the switch portion 28.

When the door is judged to be closed, then in the step S15 the seatbelt condition is judged whether the occupant of the vehicle fastens seatbelt or not by checking the seatbelt signal from the seatbelt switch in the switch portion 28.

If the seatbelt is judged to be fastened, then the process goes to step S16 to judge whether the ignition switch is ON or not by checking the ignition key signal from the ignition key in the switch portion 28.

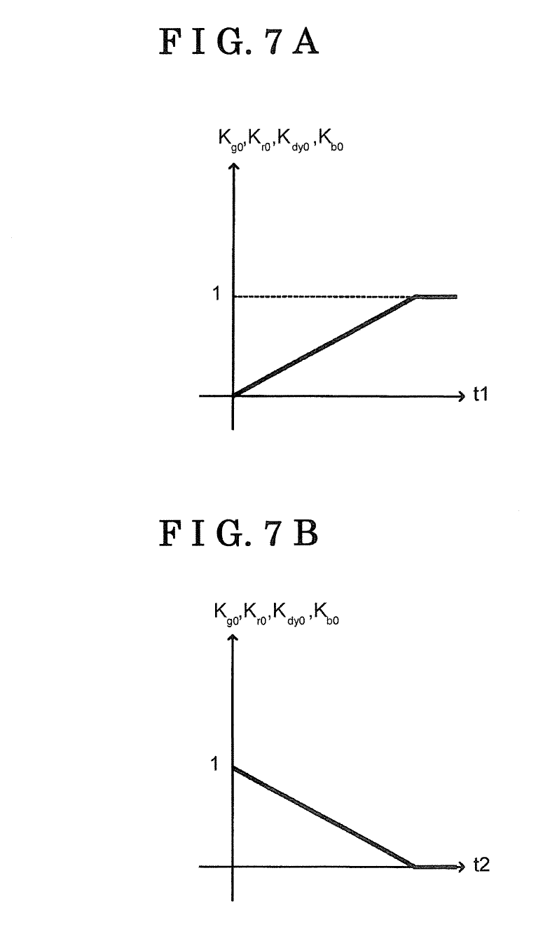

In the step S16, if the ignition switch is judged to be ON, smooth function is set at the step S17 for smoothly starting the automatic position control for the vehicle seat 10. The coefficients K_{g0}, Kᵣ₀, K_{dγ0} and K_{b0} are the values for identifying the operation amount of moving the seat 10 by driving the lateral direction actuator 20 and the turning direction actuator 21 and these values are identified corresponding to the elapsed time t1 from the automatic position control starting as shown in FIG. 7 (A).

If the position control device is not in the automatic mode (“No” in the step S12), or if the vehicle speed V is under the reference speed Kv (“No” at the step S13), or if the door is not closed (“No” at the step S14), or if the seatbelt is not fastened (“No” at the step S15), or if the ignition switch is not ON (“No” at the step S16), the process goes to step S18 to judge whether the automatic position control is still continuing or not.

If the automatic position control is still continuing, the smooth function is set for smoothly terminating the automatic control. In the step S19, the coefficients K_{g0}, Kᵣ₀, K_{dγ0} and K_{b0} for identifying the operation amount of moving the seat 10 by driving the lateral direction actuator 20 and the turning direction actuator 21 are identified corresponding to the elapsed time t1 after the process in the step S19 first started, as shown in FIG. 7 (B).

If the position control is judged to be abnormal at the step S11, or if the automatic position control is not continuing at the step S18, In the step S20, the coefficients K_{g0}, Kᵣ₀, K_{dγ0} and K_{b0} for identifying the operation amount of moving the seat 10 by driving the lateral direction actuator 20 and the turning direction actuator 21 are identified to “zero”. After the execution of step S20, the system may return to either step S4 or S2.

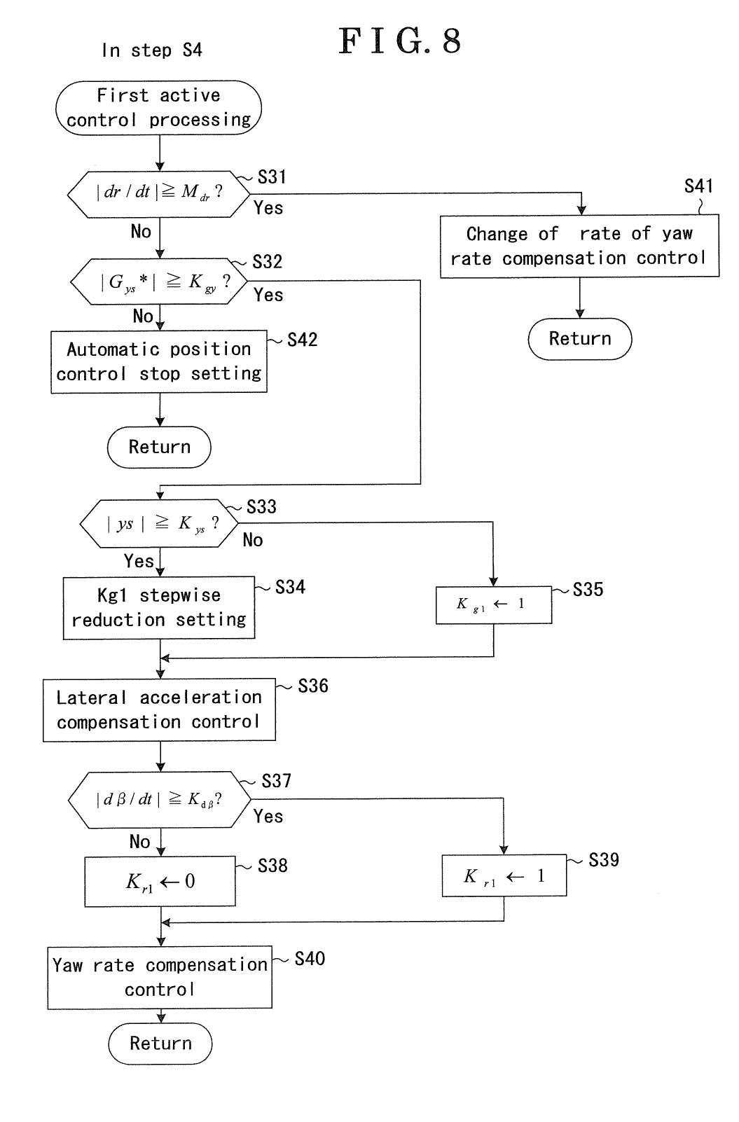

After the execution of step S3 (automatic position control judgment processing), the control information-processing portion 24 executes the predetermined automatic position control setting processing (step S4 in FIG. 4). The predetermined automatic position control setting processing is shown in FIG. 8 as an example of the flowchart.

In FIG. 8, the detail of the step S4 will be explained hereinafter. The first active control processing first judges whether the absolute value of yaw rate change dγ/dt has reached to the first threshold value M_{dγ} by the yaw rate of change judgment portion 70 in the vehicle condition judgment processing portion 51 (step S31).

If the absolute value of yaw rate change dγ/dt has not reached to the first threshold value M_{dγ}, then the absolute value of the lateral acceleration G_{ys}* identified by the lateral direction drive control portion 52 and indicated in the formula 1 has reached to the predetermined control start threshold value K_{gy} at the step S32. The threshold value K_{gy} is predetermined in advance by a test for judging whether the lateral direction actuator 20 can be actuated or not for compensation of the lateral acceleration.

When the absolute value of the lateral acceleration G_{ys}* has reached to the predetermined control start threshold value K_{gy} at the step S32, then goes to step S33 to judge whether or not the position ys (absolute value) of the seat 10 in the lateral direction of the vehicle identified by the lateral direction position sensor 22 and the detection result identification portion 60 in the vehicle condition identification processing portion 50 has reached to a predetermined position K_{ys} which is just before the end position in the lateral direction. The predetermined position K_{ys} is identified to be a position, which is a predetermined distance before the displacement (movement) end area of the seat 10.

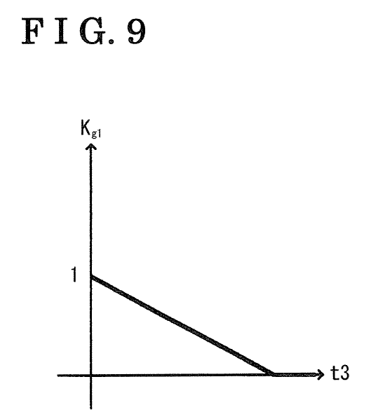

At the step S33, when the position ys of the seat 10 in lateral direction has reached to the predetermined position K_{ys} the coefficient K_{g1} is set to stepwise reduce the value thereof. The coefficient K_{g1} is used for identifying the operation amount to move the seat 10 in the lateral direction by the lateral direction actuator 20 (step S34). The value K_{g1} can be set to correspond to the lapsed time t3 from the first execution of the process in step S34 as shown in FIG. 9, wherein the y-axis indicates the value K_{g1} and the x-axis indicates the time t3 from the start of the process in step S34. Another setting of this value is made by setting the value to correspond to the remaining distance from the position ys to the movable end in lateral direction. The value is reduced in accordance with the movement of the seat position ys to the movable end in lateral direction.

When the position ys of the seat 10 in lateral direction has not reached to the predetermined position K_{ys} at the step S33, the value K_{g1} is set to 1 (one) at the step S35.

After the execution of either one of the processes at step S34 and step S35, the lateral direction actuator 20 is driven to compensate the lateral acceleration G_{ys}* as indicated in the formula 1 at the step S36. The lateral direction drive control portion 52 identifies the control contents (such as input pulse frequency, motor drive current, motor drive voltage) of the lateral direction actuator 20 based on the value of lateral acceleration G_{ys}*, coefficient values of K_{g0} and K_{g1} and transmits drive instruction to the actuator 20 corresponding to the identified results.

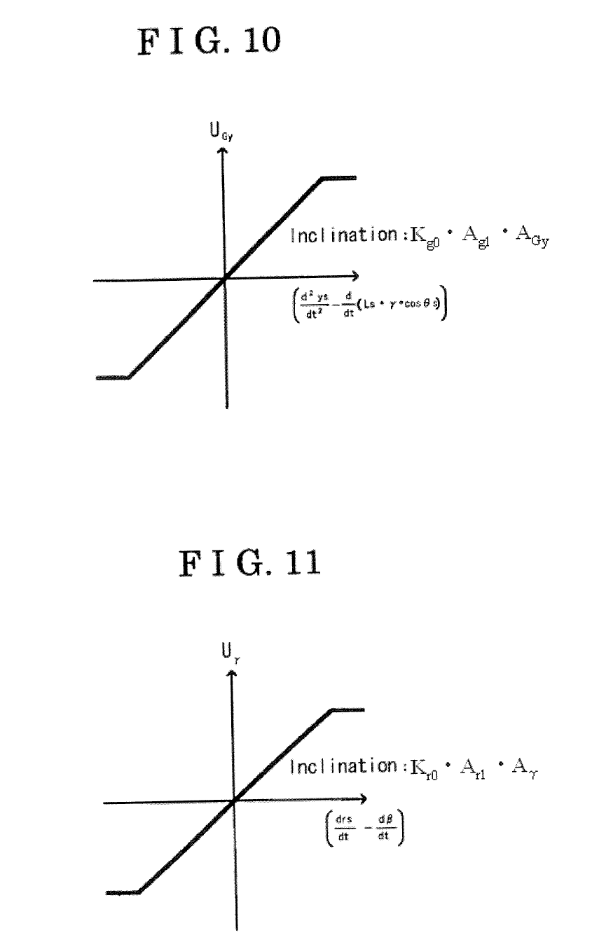

In the control system, assuming that the lateral acceleration generated at the seat 10 being the control amount and the compensated lateral acceleration by the lateral direction actuator 20 being the target value, the operation amount U_{Gy} given to the vehicle seat by the lateral direction actuator 20 can be illustrated by the formula 5 bellow and schematically illustrated in FIG. 10 as well. The coefficient A_{Gy} in the formula 5 indicates the control gain for lateral acceleration by the lateral direction actuator 20.

U_{Gy}=K_{g0}·K_{g1}·A_{Gy}·(d²ys/dt²−d/dt(Lₛ*γ*cosθs)) formula 5:

After the execution of process in step S36, the next step S37 judges whether the absolute value of the slip angle change rate dβ/dt has reached to a predetermined value K_{dβ} which is predetermined as the second change rate threshold value by the change of rate of slip angle judgment portion 71.

In the step S37, if the absolute value of the slip angle change rate dβ/dt has not reached to the predetermined value K_{dβ}, the coefficient Kᵣ₁ for identifying the operation amount of the seat 10 in turning direction (rotation) by the turning direction actuator 21 is set to be 0 (zero) at the step S38. If the absolute value of the slip angle change rate dβ/dt has reached to the predetermined value K_{dβ}, the coefficient Kᵣ₁ is set to be 1 (one) at the step S39.

After the execution of either one of the processes at step S38 and step S39, the turning direction actuator 21 is driven to compensate the yaw rate γs* as indicated in the formula 2 at the step S40. The turning direction drive control portion 53 identifies the control contents (such as input pulse frequency, motor drive current, motor drive voltage) of the turning direction actuator 21 based on the value of yaw rate γs*, coefficient values of Kᵣ₀ and Kᵣ₁ and transmits drive instruction to the actuator 21 corresponding to the identified results.

In the control system, assuming that the yaw rate generated at the seat 10 being the control amount and the compensated yaw rate by the turning direction actuator 21 being the target value, the operation amount U_{γ} given to the vehicle seat by the turning direction actuator 21 can be illustrated by the formula 6 bellow and schematically illustrated in FIG. 11 as well. The coefficient A_{γ} in the formula 6 indicates the control gain for yaw rate by the turning direction actuator 21.

U_{γ}=Kᵣ₀·Kᵣ1·A_{γ}·(dγs/dt−dβ/dt) formula 6:

In the step S31, if the absolute value of the rate of change of yaw rate dγ/dt has reached to the first predetermined value K_{dγ}, the turning direction actuator 21 is driven to compensate the change of rate of yaw rate (dγs/dt)* at the step S41. In this step S41, the turning direction drive control portion 53 identifies the control contents (such as input pulse frequency, motor drive current, motor drive voltage) of the turning direction actuator 21 based on the value of change of rate of yaw rate (dγs/dt)*, coefficient value of K_{dγ0} and transmits drive instruction to the actuator 21 corresponding to the identified results.

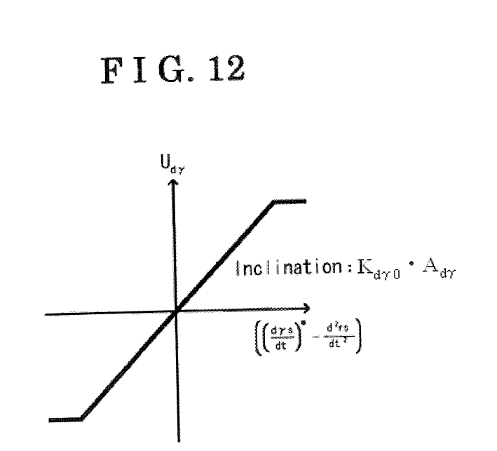

In the control system, assuming that the yaw rate change ratio generated at the seat 10 being the control amount and the compensated yaw rate change ratio by the turning direction actuator 21 being the target value, the operation amount U_{dγ} given to the vehicle seat by the turning direction actuator 21 can be illustrated by the formula 7 bellow and schematically illustrated in FIG. 12 as well. The coefficient A_{dγ} in the formula 7 indicates the control gain for yaw rate by the turning direction actuator 21.

U_{dγ}=K_{dγ0}·A_{dγ}·((dγs/dt)*−d²γs/dt²) formula 7:

In the step S32, if the absolute value of the lateral acceleration G_{ys}* has not reached to the control start threshold value K_{gy}, the first active control processing is terminated after the stopping of setting of automatic position control at the step S42.

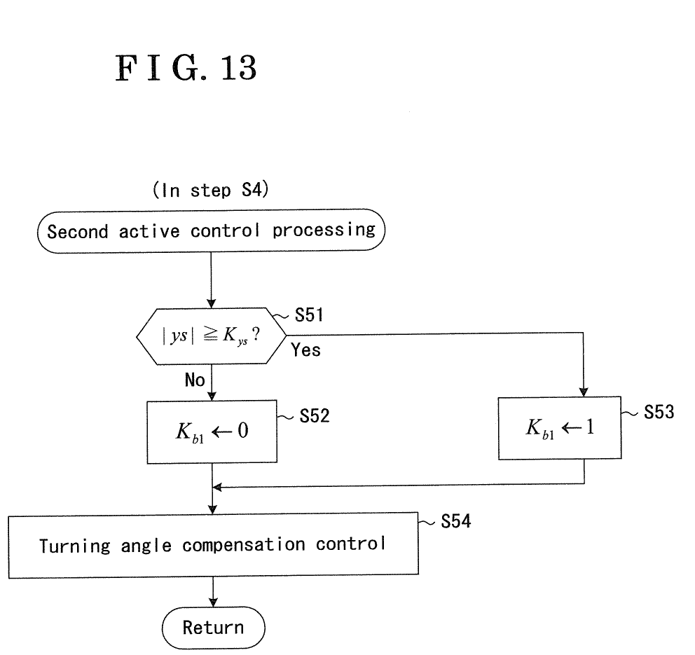

In the step S4 in FIG. 4, the second active control processing as shown in FIG. 13 will be also executed at the automatic position control setting processing. The second active control processing judges whether the absolute value of the turning angle rs* indicated in the formula 4 has reached to the predetermined control start threshold value K_{θ} (step S51). The value K_{θ} is identified in advance by a test for the threshold value to judge whether the turning direction actuator 21 can be actuated for compensation of the movement of the seat 10 in the turning direction according to the vehicle turning radius R.

In the step S51, if the absolute value of the turning angle rs* has not reached to the control start threshold value K_{β}, the coefficient K_{b1} for identifying the operation amount of the seat 10 in turning direction (rotation) by the turning direction actuator 21 is set to be 0 (zero) at the step S52. If the absolute value of the turning angle rs* has reached to the control start threshold value K_{β}, the coefficient K_{b1} is set to be 1 (one) at the step S53.

After the execution of either one of the processes at step S52 and step S53, the turning direction actuator 21 is driven to compensate the turning angle rs* as indicated in the formula 4 at the step S54. The turning direction drive control portion 53 identifies the control contents (such as input pulse frequency, motor drive current, motor drive voltage) of the turning direction actuator 21 based on the value of turning angle rs*, coefficient values of K_{b0} and K_{b1} and transmits drive instruction to the actuator 21 corresponding to the identified results.

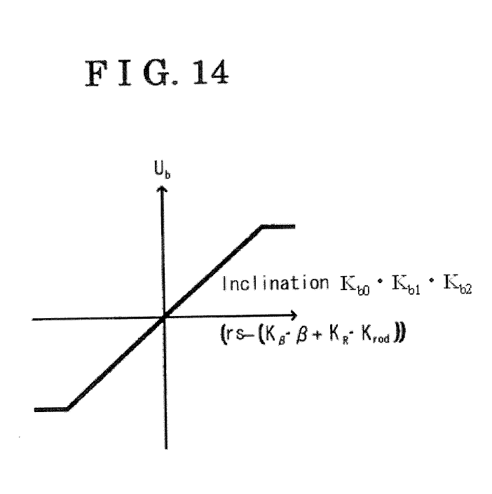

In the control system, assuming that the turning angle of the seat 10 being the control amount and the compensated turning angle by the turning direction actuator 21 being the target value, the operation amount U_{b} given to the vehicle seat by the turning direction actuator 21 can be illustrated by the formula 8 bellow and schematically illustrated in FIG. 14 as well. The coefficient A_{b} in the formula 8 indicates the control gain for turning angle by the turning direction actuator 21.

U_{b}=K_{b0}*K_{b1}·A_{b}·(rs−(K_{β}·β+K_{R}·K_{rad})) formula 8:

After the execution of process of the first active control processing as shown in FIG. 8 at the step S4 and the second active control processing as shown in FIG. 13, the system goes back to the step S2.

By the operation explained above, the lateral direction actuator 20 moves the vehicle seat 10 in the lateral direction of the vehicle. This can restrain any unnecessary lateral acceleration due to the distance from the vehicle center of gravity at the position of the seat 10. Accordingly, seated comfort can be improved during the vehicle driving.

Further, when the vehicle seat 10 is moved in the lateral direction, the evolutional movement and the rotational movement generated at the vehicle seat 10 can be agreed to improve the sitting comfort.

Further, in FIG. 8, when the absolute value of the yaw rate change ratio dγ/dt has reached to the first change ratio threshold value, the yaw rate change ratio (dγs/dt)* can be compensated at the step S41 to restrain a sudden change of yaw rate to improve the drive comfort of the vehicle.

As shown in FIG. 13, the turning angle rs* can be compensated in response to the slip angle B and the turning radius R of the vehicle at the second active control processing.

As shown in FIG. 8, when the absolute value of the lateral acceleration G_{ys}* has reached to the control start threshold value K_{gy}, the lateral acceleration can be compensated at the step S36 to reduce the consumption of electric power and effective to the measures for NVH (noise, Vibration and harshness).

Further, when the absolute value of the slip angle change of ratio dβ/dt at the step S37 has reached to the second change of ratio threshold value, the yaw rate is compensated at the step S40. If the absolute value of the change of rate of the slip angle β/dt at the step S37 has not reached to the second change of ratio threshold value, the coefficient Kᵣ₁ is set to zero at the step S38 not to compensate the yaw rate to reduce the consumption of electric power and effective to the measures for NVH.

The flowcharts and hardware structures are only the examples of the invention and accordingly any changes may be made as far as such are within the scope of the invention. For example, at the step S4 in FIG. 4, the automatic position control processing may be performed either one of the first and the second active control processing. Further, either one of the operations may be made between the two operations, lateral movement of the vehicle seat 10 by the lateral direction actuator 20 and the turning operation by the turning direction actuator 21.

The main portion of the seat position control device 1 structured by the control information processing portion 24 can be executed by using a normal computer system instead of the exclusive system for the control device. The information-processing portion 24 can be formed by the computer readable memory media for storing the computer programs for executing the processes in the flowcharts in FIG. 4, FIG. 6, FIG. 8 and FIG. 13. Such memory media may be an IC memory, magnetic memory disc or card, optical magnetic memory disc or card. The stored programs are distributed and installed in a computer for execution. The programs may be also stored in a memory device in a server device on communication network, such as Internet.

Only the application program portion can be stored in the memory media in case of the function of the control information-processing portion 24 is achieved by cooperation of the OS (Operation System) and application programs.

It is possible to distribute the programs via communication network by overlapping the programs in the carrier. The programs can be posted on the BBS (Bulletin Board System) on the communication network and distributed via the network. Starting up the program under the control of the OS can perform the execution.

The principles, preferred embodiment and mode of operation of the present invention have been described in the foregoing specification. However, the invention, which is intended to be protected, is not to be construed as limited to the particular embodiment disclosed. Further, the embodiment described herein is to be regarded as illustrative rather than restrictive. Others may make variations and changes, and equivalents employed, without departing from the spirit of the present invention. Accordingly, it is expressly intended that all such variations, changes and equivalents that fall within the spirit and scope of the present invention as defined in the claims, be embraced thereby.

What we claim is:

1. A seat position control device for a vehicle, comprising:
a lateral direction actuator for moving a position of a seat of the vehicle in a lateral direction of the vehicle;
a turning direction actuator for moving the position of the seat of the vehicle in a turning direction of the vehicle;
a motion condition identification means for identifying a motion condition of the vehicle;
a lateral direction drive control means for moving the position of the seat in the lateral direction of the vehicle by driving the lateral direction actuator based on the motion condition of the vehicle identified by the motion condition identification means; and
a turning direction drive control means for moving the position of the seat in the turning direction of the vehicle by driving the turning direction actuator based on the motion condition of the vehicle identified by the motion condition identification means.

2. The seat position control device for vehicle, according to claim 1, wherein
the motion condition of the vehicle identified by the motion condition identification means includes a yaw rate generated at the vehicle, and
the lateral direction drive control means drives the lateral direction actuator to move the position of the seat in the lateral direction of the vehicle with a target value of a lateral acceleration defined based on a distance from the center of gravity of the vehicle to the position of the seat, an angle formed by a line connecting the center of gravity and the position of the seat relative to the lateral direction of the vehicle and the yaw rate identified by the motion condition identification means.

3. The seat position control device for vehicle, according to claim 1, wherein
the motion condition of the vehicle identified by the motion condition identification means includes a yaw rate generated at the vehicle, and
the turning direction drive control means drives the turning direction actuator to move the position of the seat in the turning direction of the vehicle with a target value of a change of rate of the yaw rate at the seat of the vehicle defined based on the change of rate of the yaw rate identified by the motion condition identification means.

4. The seat position control device for vehicle, according to claim 1, further comprising
a slip angle identification means for identifying a slip angle generated at the center of gravity of the vehicle based on the motion condition identified by the motion condition identification means, wherein
the turning direction drive control means drives the turning direction actuator to move the position of the seat in the turning direction of the vehicle with a target value of a yaw rate at the seat of the vehicle defined based on the change of rate of the slip angle identified by the slip angle identification means.

5. The seat position control device for vehicle, according to claim 1, further comprising
a motion condition judgment means for judging whether the motion condition identified by the motion condition identification means is a preset motion condition or not; and
A slip angle identification means for identifying a slip angle generated at the center of gravity of the vehicle based on the motion condition detected by the motion condition identification means, wherein
a quantity of the motion condition includes a yaw rate,
the motion condition judgment means includes a first change of rate judging means for judging whether the absolute value of the change of rate of the yaw rate has reached to a first change of rate threshold value identified by the motion condition identification means and a second change of rate judging means for judging whether the absolute value of the change of rate of the slip angle identified by the slip angle identification means has reached to a second change of rate threshold value,
the turning direction drive control means drives the turning direction actuator to move the position of the seat in the turning direction of the vehicle with a target value of the change of rate of the yaw rate at the seat of the vehicle defined by the change of rate of the yaw rate identified by the motion condition identification means when the first change of rate judging means judges change of rate of the yaw rate has reached to the first change of rate threshold value and drives the turning direction actuator to move the position of the seat in the turning direction with a target value of a yaw rate at the seat of the vehicle defined based on the change of rate of the slip angle identified by the slip angle identification means when the first change of rate judging means judges the yaw rate change of rate has not reached to the first change of rate threshold value, and
the second change of rate judging means judges the slip angle change of rate has reached to the second change of rate threshold value and the lateral direction drive control means drives the lateral direction actuator to move the position of the seat in the lateral direction of the vehicle with a target value of a lateral acceleration defined based on a distance from the center of gravity of the vehicle to the position of the seat, an angle formed by a line connecting the center of gravity and the position of the seat relative to the lateral direction of the vehicle and the yaw rate identified by the motion condition identification means.

6. The seat position control device for vehicle, according to claim 1, wherein
the turning direction drive control means moves the position of the seat in the turning direction of the vehicle until the movement of the seat reaches to an angle defined based on the slip angle and the turning radius of the vehicle.

7. The seat position control device for vehicle, according to claim 6, wherein
the turning direction drive control means moves the position of the seat in the turning direction of the vehicle so that a displacement angle of the seat becomes greater when the turning radius of the vehicle is smaller compared to the situation where the turning radius is greater.

8. A seat position control device for a vehicle comprising:
a lateral direction actuator for moving a position of a seat of the vehicle in a lateral direction of the vehicle;
a motion condition identification means for identifying a motion condition of the vehicle including a yaw rate generated at the vehicle; and
a lateral direction drive control means for driving the lateral direction actuator to move the position of the seat in the lateral direction with a target value of a lateral acceleration defined based on a distance from the center of gravity of the vehicle to the position of the seat, an angle formed by a line connecting the center of gravity and the position of the seat relative to the lateral direction of the vehicle and the yaw rate identified by the motion condition identification means.

9. A seat position control device for a vehicle comprising:
a turning direction actuator for moving a position of a seat of the vehicle in a turning direction of the vehicle;
a motion condition identification means for identifying a motion condition of the vehicle including a yaw rate generated in the vehicle; and
a turning direction drive control means for driving the turning direction actuator to move the position of the seat in the turning direction with a target value of a yaw rate change of rate defined based on the yaw rate change of rate identified by the motion condition identification means.
